(19) United States
(12) Patent Application Publication
(10) Pub. No.: US 2004/0047964 A1
(43) Pub. Date: Mar. 11, 2004

(54) Milk product which can be foamed by shaking

(76) Inventors: Michel John Arthur Groux, Lauperswil (CH); Madansinh Vaghela, La Tour-de-Peilz (CH); Christiaan Bisperink, EZ Ravenstein (NL); Kosol Kijamnajsuk, Niederhuenigen (CH)

Correspondence Address: WINSTON & STRAWN, PATENT DEPARTMENT, 1400 L STREET, N.W., WASHINGTON, DC, 20005-3502, US

(21) Appl. No.: 10/622,115

(22) Filed: Jul. 18, 2003

Related U.S. Application Data
(63) Continuation of application No. PCT/EP02/01031, filed on Jan. 25, 2002.

(30) Foreign Application Priority Data
Jan. 26, 2001 (EP) 01101868.6

(51) Int. Cl. A23J 3/00

(52) U.S. Cl. 426/569

(57) ABSTRACT

The invention relates to a milk product which includes 0 to 40% fat, 5% to 23% non-fat solids, a mixture of at least two emulsifiers, a foam stabilizer, and water. The product forms a foam at room temperature when shaken or may be foamed with a foaming device. The emulsifiers include propylene glycol monostearate, sorbitan tristearate, and unsaturated monoglyceride, and the foam stabilizer is a sodium alginate or a mixture of microcrystalline cellulose and carboxymethylcellulose.

### CROSS-REFERENCE TO RELATED APPLICATIONS

This application is a continuation of International Application No. PCT/EP02/01031, filed Jan. 25, 2002, the contents of which are expressly incorporated herein by reference.

### FIELD OF THE INVENTION

The present invention concerns a milk product which can be foamed by simple hand shaking.

### BACKGROUND OF THE INVENTION

It is known on the market to have a milk product which can be foamed by simple shaking, for example for making a milk-shake. This milk product contains as a functional ingredient for allowing such foaming a vegetable protein. The problem with this type of product is that the foaming is poor if the product is sterilized, the foam created is not stable, and the product is not stable in hot coffee, since it coagulates.

### SUMMARY OF THE INVENTION

The invention relates to a milk product which includes 0 to 40% fat, 5% to 23% non-fat solids, a mixture of at least two emulsifiers, a foam stabilizer, and water. The product forms a foam at room temperature when shaken or may be foamed with a foaming device. Preferably, the emulsifiers include propylene glycol monostearate, sorbitan tristearate, and unsaturated monoglyceride, and the foam stabilizer is a sodium alginate or a mixture of microcrystalline cellulose and carboxymethylcellulose.

When the product contains 0 to 25% fat, the product also includes 0.3% to 0.9% propylene glycol monostearate, sorbitan tristearate, carboxymethylcellulose, monocrystalline cellulose, and 0.005% to 0.015% unsaturated monoglyceride. The milk product of claim 1, comprising about 25% to 40% fat, sodium alginate, 2.4% to 3% propylene glycol monostearate, and 0.1% to 0.15% unsaturated monoglyceride. The fat may be present as a dairy fat, a non-dairy fat, or a mixture thereof. Optional ingredients include one or more of carbohydrates, mineral salts, colorants, or flavorings.

The invention also relates to a method of forming a milk product that includes dissolving propylene glycol monostearate (PGMS), sorbitan tristearate (STS), and unsaturated monoglyceride in skim milk to form an emulsion; adding cream to the emulsion; adding a foam stabilizer to the emulsion; and dissolving the emulsion in water. Optionally, the method may also include sterilizing, UHT-treating, or pasteurizing the product.

### DETAILED DESCRIPTION OF THE INVENTION

The present invention relates to a milk product, wherein it is possible, that may be foamed by simple hand shaking, independently of the way the product is produced. The milk product does not require cooling prior to foaming, wherein the foam remains stable for a long time on cold and also on hot beverages and the product provides a good whitening power.

The present invention concerns a milk product containing from 0 to 40% fat, from 5% to 23% non-fat solids, along with other ingredients and water. The product can be foamed at room temperature either by shaking or with a foaming device. The product may also contain a mixture of at least two emulsifiers and a foam stabilizer.

The concept of the invention is applicable to low fat products, but also to more fatty products. The fat content of the products can be totally or partially from animal origin, that means it is possible to have a totally milk fat or a mixture of milk fat and vegetable fat. As low fat products, partially defatted milk, evaporated milk, or coffee cream may be used. For these types of products, the milk solid non fat content can vary broadly, for example 7% to 23%. As more fatty products, dairy whippable creams and non dairy whippable creams may be used. All the percentages given in the present specification are in weight, based on the final product.

The emulsifier mixture includes at least two compounds capable of facilitating the formation and stabilization of the foam. These emulsifiers are propylene glycol monostearate (PGMS), sorbitan tristearate (STS), and unsaturated monoglyceride. It may also be necessary to have in the milk product of the invention a foam stabilizer. This foam stabilizer is a compound formed of a combination of microcrystalline cellulose and carboxymethylcellulose (CMC) or sodium alginate alone.

In the case of a milk product having a fat content of 0 to 25%, the product contains PGMS and unsaturated monoglyceride, preferably PGMS, STS, and unsaturated monoglyceride. The foam stabilizer is microcrystalline cellulose and CMC. In the case of a milk product having a fat content of 25% to 40%, the product contains PGMS and unsaturated monoglyceride. The foam stabilizer is sodium alginate. In this case, the product is whippable and thick at room temperature.

The amount of microcrystalline cellulose (MCC) and carboxymethylcellulose (CMC) is 0.05% and 0.35%. This compound is preferably sold under the Trade-Mark Avicel by FMC. The amount of sodium alginate is 0.05% to 0.1%. The amount of propylene glycol monostearate (PGMS) is 0.3% to 3%. The amount of sorbitan tristearate (STS) is 0.005% to 0.15%. Finally, the amount of unsaturated monoglyceride is 0.005% to 0.15%.

In the case of a milk product having an amount of fat of about 0 to 25%, the amount of microcrystalline cellulose and carboxymethylcellulose is in the range of 0.05% to 0.35%, preferably about 0.22%; the amount of propylene glycol monostearate is in the range 0.3% to 3%, preferably about 0.9%; the amount of sorbitan tristearate is in the range of 0.005% to 0.15%, preferably about 0.015%; and the amount of unsaturated monoglyceride is in the range of 0.005% to 0.15%, preferably about 0.015%.

In the case of a milk product having an amount of fat of about 25% to 40%, the amount of sodium alginate is in the range of 0.05% to 0.1%, preferably about 0.07%; the amount of propylene glycol monostearate is in the range of 0.3% to 3%, preferably about 2.4%; and the amount of unsaturated monoglyceride is in the range of 0.005% to 0.15%, preferably about 0.1%.

The milk product of the invention is either pasteurized, sterilized, or UHT treated. The process for preparing the product of the invention includes the steps of dissolving in skimmed milk the three emulsifiers, eventually by heating, adding eventually cream to increase the fat content, adding the foam stabilizer, eventually dispersed in water, for obtaining a final mix. This final mix is then heated, homogenized, UHT treated, and finally filled. It is possible to fill either in jars or in spray-cans. If the milk product of the invention is sterilized, it is also possible to carry out the filling in cans.

As indicated above, the fat may be a dairy fat, a non dairy fat, or a mixture of both. When the fat is a dairy fat, it may be for instance, any milk fat source, such as butter oil, butter, real cream, or a mixture thereof. When the fat is a non-dairy fat, it may be, for instance, an edible oil or fat, preferably a vegetable oil, such as coconut oil, palm kernel oil, palm oil, cotton oil, peanut oil, olive oil, soy oil, or a mixture thereof. The milk product may be also a recombined milk product.

The other ingredients in the milk product may be chosen from the group. consisting of carbohydrates, mineral salts, colorants, and flavorings. The carbohydrates may be sugar, such as sucrose, glucose, fructose, lactose, dextrose, invert sugar, either crystalline or liquid syrup form, or mixtures thereof.

### EXAMPLES

The invention will now be further explained by the following examples.

### Comparative Example 1

To 62.5 kg of warm skim milk, 600 g of PGMS, 30 g of STS, and 50 g of unsaturated monoglyceride are added and well dispersed. To the mixture, 2 kg of hydroxypropyl ether of potato starch is added. The 29.5 kg of dairy cream are mixed and the final emulsion completed to 100 kg with water. The milk product has a fat content of 10.6%. The final mix is then preheated, homogenized, UHT treated, cooled, homogenized again, cooled, and filled into glass bottles with head space and sterilized.

As a comparison, another milk product is prepared where the starch is replaced by a compound from microcrystalline cellulose and carboxymethylcellulose (a product sold by FMC under the trade mark Avicel) at 0.22% instead of 2% for the starch. The main difference between the two products is that the product with the starch has a totally unstable foam and the product with the MCC-CMC has a much more stable foam.

### Example 2

To 62.5 kg of warm skim milk, 900 g of PGMS, 15 g of STS, and 15 g of unsaturated monoglyceride are added and well dispersed. To that mixture, 29.5 kg of dairy cream are added and finally 220 g of a compound from microcrystalline cellulose (MCC) and carboxymethylcellulose (CMC) from FMC are added. The final mixture is heated, homogenized, UHT treated, cooled, homogenized again, cooled, and stored. The fat content is 10.6% and the non-fat solids is 7.3%. The product is filled in glass jars with a head space and the jars are sterilized.

The product obtained, shaken vigorously by hand, foams very well without being previously chilled. Poured on hot coffee into a cup, the product forms a thick foam layer of about 1 cm height, which remains stable for at least 10 minutes. Part of the product disperses into the coffee, whitening it as would do any coffee creamer, without showing any flocculation. On storage, the product remains stable for months without any visible sign of physical instability. It is possible with the product of the invention to reach an overrun of about 300% (reached by using whipping tools) and the foam obtained remained stable for more than 2 hours at room temperature.

The product of the invention filled in a spray can was very foamable and stable on hot coffee. The foam height obtained was of several centimeters in a cup of coffee, permitting the preparation of a “Cafe Viennois”. The same foam, being quite stable, can easily be used as a low fat mousse comparable to a whipped dairy cream, for example, to garnish fruits and cakes.

### Example 3

The only difference from Example 2 is that the milk fat has been replaced by a vegetable fat, all additives remaining in the same proportion as. in the preceding example. The overall process as described was kept the same. The results of foaming by shaking vigorously by hand at room temperature showed an improvement over the formulation of Example 2.

### Example 4

The same basic recipe as in Example 2 was repeated, that is the fat content is 10.6% and the non-fat solids content is 7.3%. With a PGMS content of 0.3% to 0.9%, there is an improvement in the foaming properties. In the case of STS and unsaturated monoglyceride, a content of about 0.01% gives a product with a finer foam and that is more stable on hot coffee.

### Example 5

To a skimmed milk having a fat content of about 0.05% to 2%, 0.9% PGMS, 0.015% STS, 0.015% unsaturated monoglyceride, and 0.22% of a compound from microcrystalline cellulose and carboxymethylcellulose from FMC were added. The product was processed as in Example 2. As a result, the product was foamable at room temperature, although the stability of the foam was slightly poorer than the product from Example 2.

### Example 6

A dairy cream having a fat content of 30% was prepared by adding 2.4% PGMS, 0.045% STS, 0.045% unsaturated monoglyceride, and 0.22% of a compound from microcrystalline cellulose and carboxymethylcellulose from FMC. The process for the preparation is the same as in Example 2. The foamability at room temperature was poorer than the same product without additives whipped mechanically.

It is to be understood that the invention is not to be limited to the exact configuration as illustrated and described herein. Accordingly, all expedient modifications readily attainable by one of ordinary skill in the art from the disclosure set forth herein, or by routine experimentation therefrom, are deemed to be within the spirit and scope of the invention as defined by the appended claims.

What is claimed is:

1. A milk product comprising 0 to 40% fat, 5% to 23% non-fat solids, a mixture of at least two emulsifiers, a foam stabilizer, and water, wherein the product forms a white foam at room temperature that is stable for at least 10 minutes when shaken or when a foaming device is used.

2. The milk product of claim 1, wherein the emulsifiers include propylene glycol monostearate, sorbitan tristearate, and unsaturated monoglyceride, and the foam stabilizer is a sodium alginate or a mixture of microcrystalline cellulose and carboxymethylcellulose.

3. The milk product of claim 1, wherein the foam stabilizer comprises 0.05% to 0.35% of microcrystalline cellulose and carboxymethylcellulose.

4. The milk product of claim 1, comprising 0.05% to 0.1% sodium alginate.

5. The milk product of claim 1, comprising 0.3% to 3% propylene glycol monostearate.

6. The milk product of claim 1, comprising 0.005% to 0.15% sorbitan tristearate.

7. The milk product of claim 1, comprising 0.005% to 0.15% unsaturated monoglyceride.

8. The milk product of claim 1, comprising 0 to 25% fat, 0.3% to 0.9% propylene glycol monostearate, sorbitan tristearate, carboxymethylcellulose, monocrystalline cellulose, and 0.005% to 0.015% unsaturated monoglyceride.

9. The milk product of claim 1, comprising about 25% to 40% fat, sodium alginate, 2.4% to 3% propylene glycol monostearate, and 0.1% to 0.15% unsaturated monoglyceride.

10. The milk product of claim 1, wherein the fat is a dairy fat, a non-dairy fat, or a mixture thereof.

11. The milk product of claim 1, further comprising one or more of carbohydrates, mineral salts, colorants, or flavorings.

12. A method of forming a milk product which comprises:
dissolving propylene glycol monostearate (PGMS), sorbitan tristearate (STS), and unsaturated monoglyceride in skim milk to form an emulsion;
adding cream to the emulsion;
adding a foam stabilizer to the emulsion; and
dissolving the emulsion in water to form the milk product.

13. The method of claim 12, further comprising sterilizing, UHT-treating, or pasteurizing the product.

14. The method of claim 12, wherein the foam stabilizer is sodium alginate or a mixture of microcrystalline cellulose and carboxymethylcellulose (CMC).

15. A process for producing a foam that is stable for at least 10 minutes which comprises forming a foam from the milk product of claim 1 by shaking or by using a foaming device.

16. A process for producing a foam that is stable for at least 10 minutes which comprises forming a milk product by the method of claim 12 and forming a foam from the milk product by shaking or by using a foaming device.

17. A spray can that contains the milk product of claim 1 and is capable of dispensing the product as a stable white foam.
